(19) United States
(12) Patent Application Publication
(10) Pub. No.: US 2025/0006176 A1
(43) Pub. Date: Jan. 2, 2025

(54) SPEECH SYNTHESIS DEVICE, SPEECH SYNTHESIS METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventors: Yoshiki HIRUTA, Hachioji Tokyo (JP); Masatsune TAMURA, Kawasaki Kanagawa (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/884,313

(22) Filed: Sep. 13, 2024

Related U.S. Application Data
(63) Continuation of application No. PCT/JP2023/010951, filed on Mar. 20, 2023.

(30) Foreign Application Priority Data
Mar. 22, 2022 (JP) 2022-045139

(51) Int. Cl. G10L 13/047; G10L 13/033; G10L 13/06; G10L 13/10

(52) U.S. Cl. CPC G10L 13/047; G10L 13/0335; G10L 13/06; G10L 13/10

(57) ABSTRACT

The response time till generation of waveforms is improved, and detailed editing for a metrical-feature quantity based on the entire input is performable before generation of waveforms. A speech synthesis device includes an analyzing unit, a first-processing unit, and a second-processing unit. The analyzing unit analyzes an input text and generates a language feature quantity sequence including one or more vectors indicating a language feature quantity. The first-processing unit includes an encoder that converts the language feature quantity sequence into an intermediate expression sequence including one or more vectors indicating a latent variable, using a first neural network; and includes a metrical-feature quantity decoder that generates a metrical-feature quantity from the intermediate expression sequence using a second neural network. The second-processing unit includes a speech waveform decoder that successively generates speech waveforms from the intermediate expression sequence and the metrical-feature quantity using a third neural network.

### CROSS-REFERENCE TO RELATED APPLICATIONS

This application is a continuation of International Patent Application No. PCT/JP2023/010951 filed on Mar. 20, 2023 which claims the benefit of priority from Japanese Patent Application No. 2022-045139, filed on Mar. 22, 2022; the entire contents of all of which are incorporated herein by reference.

### FIELD

Embodiments described herein relate generally to a speech synthesis device, a speech synthesis method, and a computer program product.

### BACKGROUND

In recent years, speech synthesis devices utilizing a deep neural network (DNN) are known. Among such devices, a plurality of DNN speech synthesis technologies particularly based on an encoder/decoder structure has been proposed.

For example, in Japanese Unexamined Patent Application Publication (Translation of PCT application) No. 2020-515899, a sequence-to-sequence recurrent neural network is proposed for which a sequence of characters of a natural language is treated as the input and a spectrogram of verbal utterances is output. Moreover, for example, in Yi Ren, Chenxu Hu, Xu Tan, Tao Qin, Sheng Zhao, Zhou Zhao, Tie-Yan Liu, “FastSpeech2: Fast and High-Quality End-to-End Text to Speech,” in Proc. ICLR, 2021, a DNN speech synthesis technology is proposed that is based on an encoder/decoder structure utilizing a self-attention mechanism with the phoneme notations of a natural language as the input, and that outputs, via the continuation length, the pitch, and the energy of each phoneme notation, a Mel spectrogram or a speech waveform.

### BRIEF DESCRIPTION OF THE DRAWINGS

FIG. 1 is a diagram illustrating an exemplary functional configuration of a speech synthesis device according to a first embodiment;

FIG. 2 is a diagram illustrating exemplary vector expressions of context information according to the first embodiment;

FIG. 3 is a flowchart for explaining an example of a speech synthesis method according to the first embodiment;

FIG. 4 is a diagram illustrating an exemplary functional configuration of a metrical feature quantity decoder according to the first embodiment;

FIG. 5 is a flowchart for explaining an example of a generation method for generating a metrical feature quantity according to the first embodiment;

FIG. 6 is a diagram illustrating an exemplary functional configuration of a speech synthesis device according to a second embodiment;

FIG. 7 is a flowchart for explaining an example of a speech synthesis method according to the second embodiment;

FIG. 8 is a diagram for explaining an example of the operations performed by an editing unit according to the second embodiment;

FIG. 9 is a diagram illustrating an exemplary functional configuration of a speech synthesis device according to a third embodiment;

FIG. 10 is a diagram illustrating an exemplary functional configuration of a consecutive-speech-frame count generating unit according to the third embodiment;

FIG. 11 is a diagram illustrating an example of pitch waveforms according to the third embodiment;

FIG. 12 is a flowchart for explaining an example of a speech synthesis method according to the third embodiment;

FIG. 13 is a diagram for explaining an example of the operations performed by the consecutive-speech-frame count generating unit according to the third embodiment;

FIG. 14 is a diagram illustrating an exemplary functional configuration of a speech synthesis device according to a fourth embodiment;

FIG. 15 is a flowchart for explaining an example of a speech synthesis method according to the fourth embodiment;

FIG. 16 is a diagram for explaining an example of the operations performed by a first processing unit according to the fourth embodiment; and

FIG. 17 is a diagram illustrating an exemplary hardware configuration of the speech synthesis device according to the first to fourth embodiments.

### DETAILED DESCRIPTION

In DNN speech synthesis based on an encoder/decoder structure, two types of neural networks called an encoder and a decoder are used. The encoder converts an input sequence into a latent variable. A latent variable represents a value that cannot be directly observed from outside; and, in the speech synthesis, a sequence of intermediate expressions is used in which each intermediate expression represents the conversion result of an input. The decoder converts the obtained latent variable (i.e., the intermediate expression sequence) into an acoustic feature quantity and an acoustic waveform. If the intermediate expression sequence has a different sequence length than the sequence length of the acoustic feature quantity output by the decoder, the situation can be dealt by using an attention mechanism as disclosed in Japanese Unexamined Patent Application Publication (Translation of PCT application) No. 2020-515899, or by separately obtaining the frame count of the acoustic feature quantity corresponding to each intermediate expression as explained in Yi Ren, Chenxu Hu, Xu Tan, Tao Qin, Sheng Zhao, Zhou Zhao, Tie-Yan Liu, “FastSpeech2: Fast and High-Quality End-to-End Text to Speech,” in Proc. ICLR, 2021.

However, in the conventional technology, because of using a decoder that is based on an attention mechanism, there arises a problem of necessitating processing the entire input at the time of synthesis, resulting in prolonged response time. As the improvement measure, successively outputting all acoustic feature quantities and speech waveforms is thinkable. However, there arises a problem that, until the entire input is processed, it is not possible to perform detailed editing with respect to the feature quantity related to the meter (metrical feature quantity) such as the phoneme duration or the voice (speech) pitch/tone.

According an embodiment, a speech synthesis device includes one or more hardware processors configured to function as an analyzing unit, a first processing unit, and a second processing unit. The analyzing unit analyzes an input text and generates a language feature quantity sequence that includes one or more vectors indicating a language feature quantity. The first processing unit includes an encoder that converts the language feature quantity sequence into an intermediate expression sequence that includes one or more vectors indicating a latent variable, using a first neural network, and a metrical feature quantity decoder that generates a metrical feature quantity from the intermediate expression sequence using a second neural network. The second processing unit includes a speech waveform decoder that successively generates a speech waveform from the intermediate expression sequence and the metrical feature quantity using a third neural network. Exemplary embodiments of a speech synthesis device, a speech synthesis method, and a computer program product that enable solving the problems mentioned above are described below in detail with reference to the accompanying drawings.

### First Embodiment

Firstly, the explanation is given about an exemplary functional configuration of a speech synthesis device according to a first embodiment.

### Exemplary Functional Configuration

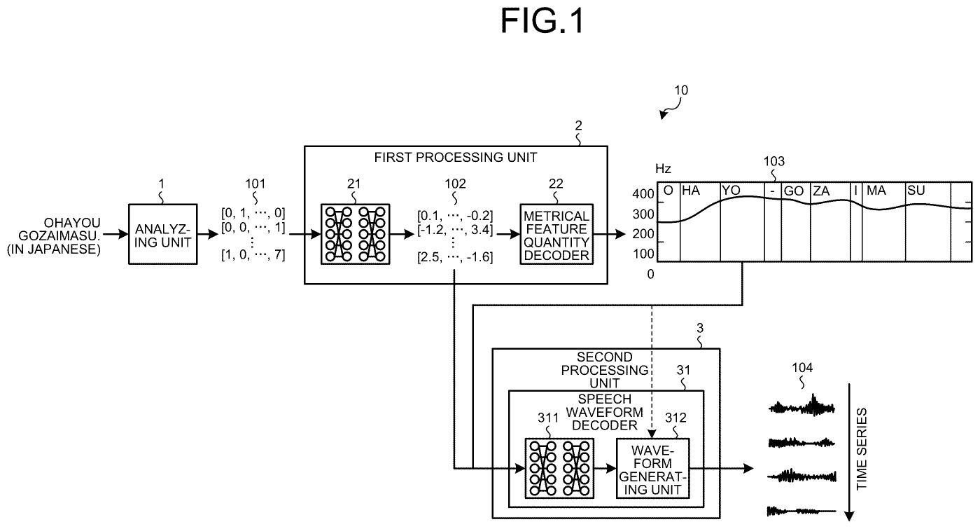

FIG. 1 is a diagram illustrating an exemplary functional configuration of a speech synthesis device 10 according to a first embodiment. In the DNN speech synthesis based on an encoder/decoder structure, the speech synthesis device 10 outputs, in advance, an intermediate expression sequence and a metrical feature quantity, and thereafter successively outputs speech waveforms. That results in achieving an improvement in the response time as compared to the conventional DNN speech synthesis operation based on an encoder/decoder structure.

The speech synthesis device 10 according to the first embodiment includes an analyzing unit 1, a first processing unit 2, and a second processing unit 3.

The analyzing unit 1 analyzes the input text and generates a language feature quantity sequence 101. The language feature quantity sequence 101 represents the information in which pieces of utterance information (language feature quantity) obtained by analyzing the input text are arranged in a chronological order. As the utterance information (language feature quantity), for example, context information used as the unit for speech classification such as phoneme/half-phone/syllable is used.

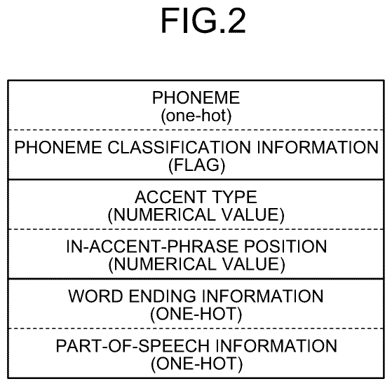

FIG. 2 is a diagram illustrating exemplary vector expressions of the context information according to the first embodiment. In FIG. 2 are illustrated exemplary vector expressions of the context information in the case in which phonemes are used as the speech units. The sequence of vector expressions is used as the language feature quantity sequence 101.

The expressions illustrated in FIG. 2 include: phonemes, phoneme classification information, accent type, in-accent-phrase position, word ending information, and part-of-speech information. The expression “phoneme” represents a one-hot vector indicating the concerned phoneme. The expression “phoneme classification information” represents flag information indicating the type of the phoneme. Herein, the type indicates classification according to speech phoneme/unvoiced phoneme, and indicates the attribute of more detailed phoneme classification.

The expression “accent type” represents a numerical value indicating the accent type of the concerned phoneme. The expression “in-accent-phrase position” represents a numerical value indicating the position of the concerned phoneme in the accent phrase. The expression “word ending information” represents a one-hot vector indicating the word ending information of the concerned phoneme. The expression “part-of-speech information” represents a one-hot vector indicating the part-of-speech information of the concerned phoneme.

Meanwhile, as the language feature quantity sequence 101, it is also possible to use information other than a sequence of vector expressions as illustrated in FIG. 2. For example, the input text can be converted into symbol strings such as Japanese text-to-speech conversion symbols defined in JEITA standard IT-4006. Then, each symbol can be converted into a one-hot vector as the utterance information; and a sequence in which the one-hot vectors are arranged in a chronological order can be treated as the language feature quantity sequence 101.

Returning to the explanation with reference to FIG. 1, the first processing unit 2 includes an encoder 21 and a metrical feature quantity decoder 22. The encoder 21 converts the language feature quantity sequence 101 into an intermediate expression sequence 102.

As explained earlier, the intermediate expression sequence 102 represents a latent variable in the speech synthesis device 10, and includes the information for enabling the metrical feature quantity decoder 22 and the second processing unit 3 to obtain a metrical feature quantity 103 and speech waveform 104, respectively. Each vector included in the intermediate expression sequence 102 indicates an intermediate expression. The sequence length of the intermediate expression sequence 102 is determined according to the sequence length of the language feature quantity sequence 101. However, the sequence length of the intermediate expression sequence 102 need not match the sequence length of the language feature quantity sequence 101. For example, a single language feature quantity can have a plurality of intermediate expressions corresponding thereto.

The metrical feature quantity decoder 22 generates the metrical feature quantity 103 from the intermediate expression sequence 102.

The metrical feature quantity 103 represents the feature quantity related to the meter such as the rate of utterance, the voice pitch, and the voice tone (intonation). The metrical feature quantity 103 includes the consecutive speech frame count in each vector that is included in the intermediate expression sequence 102, and includes the pitch feature quantity in each speech frame. Herein, a speech frame represents the unit for waveform clipping at the time of analyzing speech waveforms and obtaining the acoustic feature quantity. At the time of synthesis, the speech waveforms 104 are synthesized from the acoustic feature quantity generated for each speech frame. In the first embodiment, the interval between the speech frames is set to a fixed duration. Moreover, the consecutive speech frame count represents the number of speech frames included in the speech section corresponding to each vector included in the intermediate expression sequence 102. Examples of the pitch feature quantity include the basic frequency and the logarithm of the basic frequency.

Meanwhile, other than the examples given above, the gain in each speech frame and the continuance of each vector included in the intermediate expression sequence 102 can also be included in the metrical feature quantity 103.

The second processing unit 3 includes a speech waveform decoder 31 that successively generates the speech waveforms 104 from the intermediate expression sequence 102 and the metrical feature quantity 103, and successively outputs the speech waveforms 104. Herein, the successive generation/output operation implies performing a waveform generation operation only with respect to each section formed by sequentially sectioning the intermediate expression sequence 102 little by little from the head; and outputting the speech waveform 104 of the section. For example, in the successive generation/output operation, the speech waveform 104 is generated/output for each set of a predetermined number of samples (predetermined data length) that is arbitrarily decided by the user. By performing the successive generation/output operation, the computation related to waveform generation can be divided on a section-by-section basis, thereby enabling outputting and reproducing the speech for each section without waiting for the generation of the speech waveforms 104 corresponding to the entire input text.

More particularly, the speech waveform decoder 31 includes a spectral feature quantity generating unit 311 and a waveform generating unit 312. The spectral feature quantity generating unit 311 generates a spectral feature quantity from the intermediate expression sequence 102 and the metrical feature quantity 103.

The spectral feature quantity represents the feature quantity indicating the spectral characteristics of the speech waveform of each speech frame. The acoustic feature quantity that is required in speech synthesis is made of the metrical feature quantity 103 and the spectral feature quantity. The spectral feature quantity includes a spectral envelope indicating the vocal tract characteristics such as the formant structure of the speech, and includes information regarding a non-periodic index indicating the mixing rate of the noise component, which gets excited by the breath sound, and the harmonic component, which gets excited by the vibrations of the vocal cord. Examples of the spectral envelope information include Mel-cepstrum and Mel line spectral pair. Examples of the non-periodic index include a band frequency non-periodic index. Besides, the feature quantity regarding the phase spectrum can also be included in the spectral feature quantity, so as to enhance the reproducibility of the waveforms.

For example, from the intermediate expression sequence 102 and the metrical feature quantity 103, the spectral feature quantity generating unit 311 generates, in a chronological order, the spectral feature quantity for the number of speech frames corresponding to the predetermined number of samples.

The waveform generating unit 312 performs a speech synthesis operation using the spectral feature quantity and generates a synthesized waveform (the speech waveforms 104). For example, using the spectral feature quantity, the waveform generating unit 312 generates, in a chronological order, the speech waveform 104 for each set of a predetermined number of samples, and successively generates the speech waveforms 104. This enables, for example, chronologically synthesizing the speech waveforms 104 for each set of a predetermined number of speech waveform samples as defined by the user, thereby enabling achieving enhancement in the response time till the generation of the speech waveforms 104. Meanwhile, the waveform generating unit 312 can synthesize the speech waveforms 104 also using the metrical feature quantity 103 as may be necessary.

### Example of Speech Synthesis Method

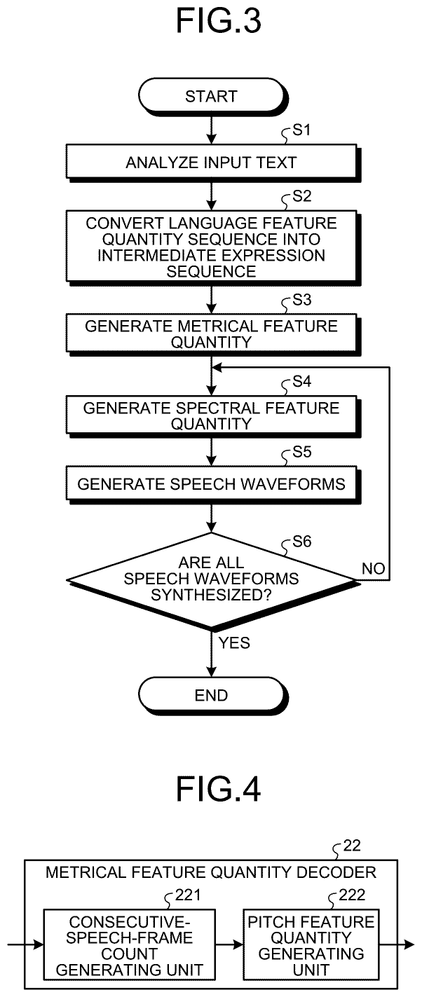

FIG. 3 is a flowchart for explaining an example of a speech synthesis method according to the first embodiment. Firstly, the analyzing unit 1 analyzes the input text and outputs the language feature quantity sequence 101 that includes one or more vectors indicating the language feature quantity (Step S1). For example, the analyzing unit 1 performs morphological analysis with respect to the input text; obtains read information and language information, such as accent information, required in speech synthesis; and outputs the language feature quantity sequence 101 from the read information and the language information. Alternatively, for example, the analyzing unit 1 can generate the language feature quantity sequence 101 regarding the input text from already-corrected read/accent information, which is separately created in advance.

Then, the first processing unit 2 performs the operations at Steps S2 and S3 and outputs the intermediate expression sequence 102 and the metrical feature quantity 103. More particularly, firstly, the encoder 21 converts the language feature quantity sequence 101 into the intermediate expression sequence 102 (Step S2). Then, the metrical feature quantity decoder 22 generates the metrical feature quantity 103 from the intermediate expression sequence 102 (Step S3).

Subsequently, the speech waveform decoder 31 of the second processing unit 3 performs the operations from Step S4 to Step S8. Firstly, the spectral feature quantity generating unit 311 generates the required amount of the spectral feature quantity from the intermediate expression sequence 102 and from the required metrical feature quantity such as the consecutive speech frame count of each vector included in the intermediate expression sequence 102 to be processed (Step S4). Then, the waveform generating unit 312 generates the required amount of the speech waveforms 104 using the spectral feature quantity (Step S5). With respect to the speech waveforms 104 generated by performing the operation at Step S5, by performing the user operations such as reproducing and saving asynchronously with respect to the second processing unit 3, the delay occurring till the start of reproduction due to wavelength generation can be suppressed.

If the synthesis of all speech waveforms 104 is not yet complete (No at Step S6), the system control returns to Step S4. By repeatedly performing the operations at Steps S4 and S5, it becomes possible to generate the overall speech waveforms 104. When the synthesis of all speech waveforms 104 is completed (Yes at Step S6), the operations end.

Given below is the detailed explanation of each constituent element of the speech synthesis device 10 according to the first embodiment.

### Details of Each Constituent Element

In the speech synthesis device 10 illustrated in FIG. 1, the encoder 21 converts the language feature quantity sequence 101 into the intermediate expression sequence 102 according to a first neural network. As the neural network, for example, by using a structure capable of processing a time series, such as a recurrent structure, a convolution structure, or a self-attention mechanism, the previous information and the subsequent information can be assigned to the intermediate expression sequence 102.

FIG. 4 is a diagram illustrating an exemplary functional configuration of the metrical feature quantity decoder 22 according to the first embodiment. The metrical feature quantity decoder 22 according to the first embodiment includes a consecutive-speech-frame count generating unit 221 and a pitch feature quantity generating unit 222.

The consecutive-speech-frame count generating unit 221 generates the consecutive speech frame count of each vector included in the intermediate expression sequence 102.

The pitch feature quantity generating unit 222 generates, from the intermediate expression sequence 102 and based on the consecutive speech frame count of each vector included in the intermediate expression sequence 102, generates a pitch feature quantity for each speech frame. Besides, for example, the metrical feature quantity decoder 22 can generate the gain for each speech frame.

In the operations performed by the consecutive-speech-frame count generating unit 221 and the pitch feature quantity generating unit 222, a neural network included in a second neural network is used. As the neural network to be used in the pitch feature quantity generating unit 222, for example, it is possible to a use a structure capable of processing a time series, such as a recurrent structure, a convolution structure, or a self-attention mechanism. This enables obtaining the pitch feature quantity in each speech frame by taking into account the previous information and the subsequent information, thereby increasing the smoothness of the synthesized speech.

### Example of Generation Method for Generating Metrical Feature Quantity

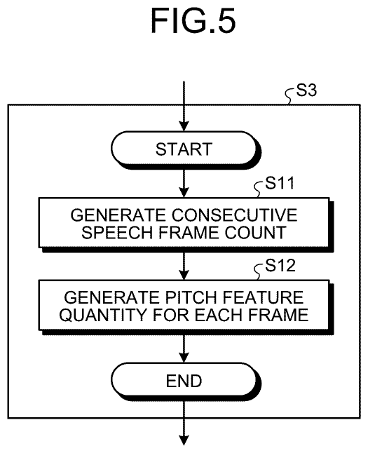

FIG. 5 is a flowchart for explaining an example of a generation method for generating the metrical feature quantity 103 according to the first embodiment. Firstly, the consecutive-speech-frame count generating unit 221 generates the consecutive speech frame count of each vector included in the intermediate expression sequence 102 (Step S11). Then, the pitch feature quantity generating unit 222 generates the pitch feature quantity for each speech frame (Step S12).

Moreover, in the speech synthesis device 10 illustrated in FIG. 1, from the intermediate expression sequence 102 and the metrical feature quantity 103, the spectral feature quantity generating unit 311 of the speech waveform decoder 31 of the second processing unit 3 generates the required amount of the spectral feature quantity, which is required for successive generation of the speech waveforms 104, using a neural network included in a third neural network. As the neural network, for example, a neural network including at least either a recurrent structure or a convolution structure is used. More particularly, as the neural network, if a unidirectional gated recurrent structure [Gated Recurrent Unit (GRU)] and a causal convolution structure are used, it becomes possible to generate a smooth spectral feature quantity without having to perform the operations regarding all speech frames. Moreover, it becomes possible to obtain the spectral feature quantity in which the time-series structure is reflected, and to achieve a smooth synthesized speech.

The waveform generating unit 312 of the second processing unit 3 performs signal processing or uses a vocoder based on the neural network included in the third neural network, and synthesizes the speech waveforms 104 required in successive generation. In the case of using a neural network, for example, waveforms can be generated according to a neural vocoder such as WaveNet proposed in A van den Oord, et al., “WAVENET: A GENERATIVE MODEL FOR RAW SPEECH”, in arxiv preprint, 2016.

As explained above, the speech synthesis device 10 according to the first embodiment includes the analyzing unit 1, the first processing unit 2, and the second processing unit 3. The analyzing unit 1 analyzes the input text and generates the language feature quantity sequence 101 that includes one or more vectors indicating the language feature quantity. In the first processing unit 2, the encoder 21 converts the language feature quantity sequence 101 into the intermediate expression sequence 102, which represents a latent variable and which includes one or more vectors, using the first neural network. Then, the metrical feature quantity decoder 22 generates the metrical feature quantity 103 from the intermediate expression sequence 102. In the second processing unit 3, the speech waveform decoder 31 successively generates the speech waveforms 104 from the intermediate expression sequence 102 and the metrical feature quantity 103.

This enables, by the speech synthesis device 10 according to the first embodiment, improving the response time till the generation of the waveforms. More particularly, in the speech synthesis device 10 according to the first embodiment, the operations are divided between the first processing unit 2 and the second processing unit 3. The first processing unit 2 outputs, in advance, the intermediate expression sequence 102 and the metrical feature quantity 103. The second processing unit 3 successively outputs the speech waveforms 104. With the feature, while a particular speech waveform 104 is being reproduced, the subsequent speech waveform 104 can be output. Hence, in the speech synthesis device 10 according to the first embodiment, the response time spans till the reproduction of the initial speech waveform 104. That represents an improvement in the response time as compared to the conventional technology in which all acoustic feature quantities and the speech waveforms 104 are obtained at once.

### Second Embodiment

Given below is the description about a second embodiment. In the second embodiment, the similar explanation to the explanation given in the first embodiment is not repeated. Thus, the explanation is given only about the differences with the first embodiment.

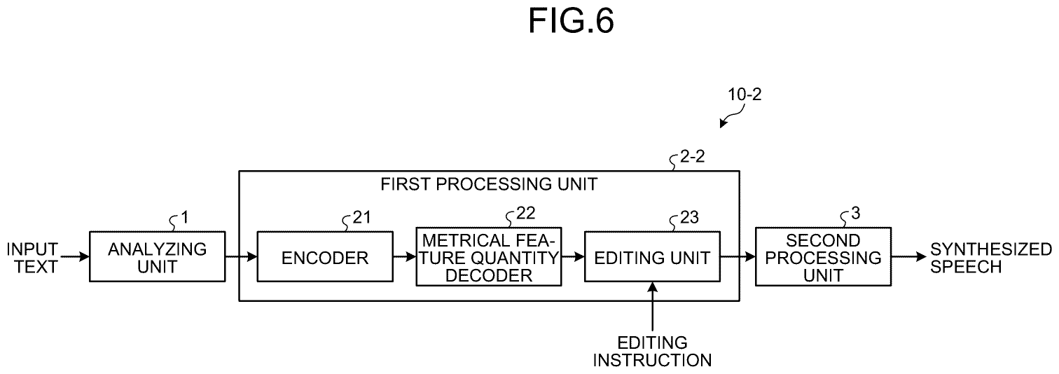

Exemplary functional configuration FIG. 6 is a diagram illustrating an exemplary functional configuration of a speech synthesis device 10-2 according to the second embodiment. In the speech synthesis device 10-2 according to the second embodiment, a first processing unit 2-1 further includes an editing unit 23. With the configuration, before the second processing unit 3 performs operations to obtain the speech waveforms 104, it becomes possible to perform detailed editing for the metrical feature quantity of the entire input text.

When an editing instruction with respect to the metrical feature quantity 103 is received, the editing unit 23 reflects the editing instruction in the metrical feature quantity 103. The editing instruction is received via, for example, a user input.

The editing instruction represents a modification instruction for modifying the value of each metrical feature quantity 103. For example, the editing instruction represents an instruction for modifying the value of the pitch feature quantity in each speech frame of a particular section. More particularly, the editing instruction represents an instruction to modify, for example, the pitch to 300 Hz from the second frame to the 10-th frame. Alternatively, for example, the editing instruction represents an instruction for modifying the consecutive speech frame count of each vector included in the intermediate expression sequence 102. Still alternatively, for example, the editing instruction represents an instruction for modifying the consecutive speech frame count of the 17-th intermediate expression included in the intermediate expression sequence 102.

Other than the examples given above, the editing instruction can also represent an instruction for projecting the uttered speech in the input text onto the metrical feature quantity 103. More particularly, the editing unit 23 uses the uttered speech in the input text that is provided in advance. Then, the editing unit 23 receives, from the input text, an instruction for projecting the metrical feature quantity 103, which is generated by the analyzing unit 1, the encoder 21, and the metrical feature quantity decoder 22, in such a way that the metrical feature quantity 103 is aligned with the metrical feature quantity of the uttered speech. In that case, the desired editing result can be obtained without direct manipulation of the value of the metrical feature quantity 103 generated from the input text.

The second processing unit 3 receives the metrical feature quantity 103 generated by the metrical feature quantity decoder 22 or receives the metrical feature quantity 103 edited by the editing unit 23.

### Example of Speech Synthesis Method

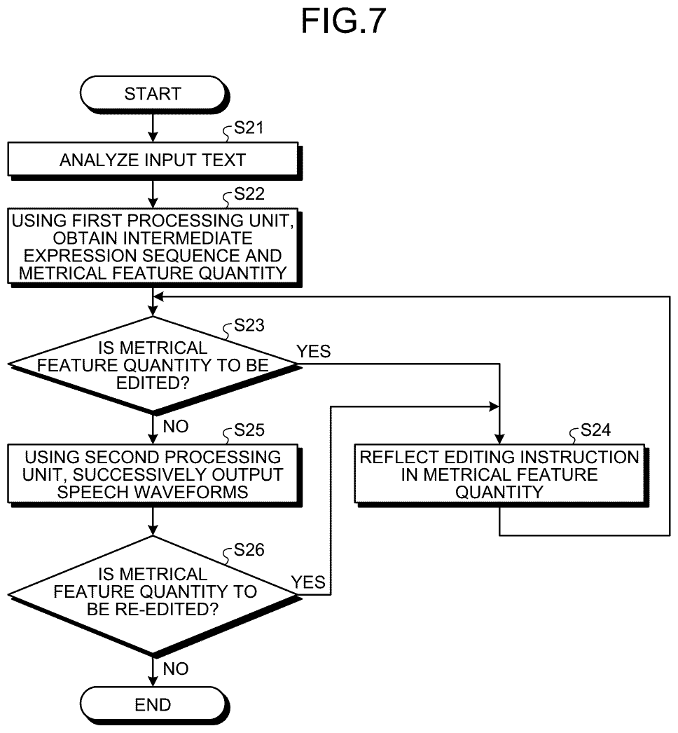

FIG. 7 is a flowchart for explaining an example of a speech synthesis method according to the second embodiment. Firstly, the analyzing unit 1 analyzes the input text and outputs the language feature quantity sequence 101 that includes one or more vectors indicating the language feature quantity (Step S21). Then, a first processing unit 2-2 obtains the intermediate expression sequence 102 and the metrical feature quantity 103 from the language feature quantity sequence 101 (Step S22).

Then, the editing unit 23 determines whether or not to edit the metrical feature quantity 103 (Step S23). The determination about whether or not to edit the metrical feature quantity 103 is performed, for example, based on the presence or absence of an unprocessed editing instruction with respect to the metrical feature quantity 103. For example, for the editing instruction, the values such as the pitch feature quantity generated based on the metrical feature quantity 103 and the continuance of each phoneme are displayed in a display device; and the values are edited by the user, for example, using a mouse operation.

If the metrical feature quantity 103 is not to be edited (No at Step S23), the system control proceeds to Step S25.

On the other hand, if the metrical feature quantity 103 is to be edited (Yes at Step S23), the editing unit 23 reflects the editing instruction in the metrical feature quantity 103 (Step S24). In the case in which the metrical feature quantity 103 needs to be generated again, such as in the case in which the consecutive speech frame count of each vector included in the intermediate expression sequence 102 is to be modified, the metrical feature quantity decoder 22 again generates the metrical feature quantity 103. The editing of the metrical feature quantity 103 is repeatedly performed as long as the input of editing instructions is received from the user.

Then, the second processing unit 3 (the speech waveform decoder 31) successively outputs the speech waveforms 104 (Step S25). The details of the operation performed at Step S25 are similar to the details given in the first embodiment. Hence, that explanation is not repeated.

Then, the waveform generating unit 312 determines whether or not to re-edit the metrical feature quantity 103 for resynthesizing the speech waveforms 104 (Step S26). If the metrical feature quantity 103 is to be re-edited (Yes at Step S26), the system control returns to Step S24. For example, when the desired speech waveforms 104 is not obtainable, an editing instruction is further received from the user and the system control returns to Step S24.

On the other hand, if the metrical feature quantity 103 is not to be re-edited (No at Step S26), the operations end.

### Details of Editing

The details of operations when the editing is metrical projection will be explained. When a projection instruction is received with respect to the metrical feature quantity 103 of the uttered speech of the input text, the editing unit 23 performs the following operations at Step S24. Firstly, the editing unit 23 analyzes the uttered speech and obtains the metrical feature quantity 103. Of the metrical feature quantity 103, the continuation length of each phoneme is obtained by performing phoneme alignment according to the utterance details of the uttered speech and extracting the phoneme boundary. Moreover, the pitch feature quantity in each speech frame is obtained by extracting the acoustic feature quantity of the uttered speech. Then, based on the phoneme continuation length obtained from the uttered speech, the editing unit 23 changes the consecutive speech frame count of each vector included in the intermediate expression sequence 102. Subsequently, the editing unit 23 changes the pitch feature quantity in each speech frame such that the pitch feature quantity is aligned with the pitch feature quantity extracted from the uttered speech. Regarding the other feature quantities included in the metrical feature quantity 103, similarly, each feature quantity is changed to be aligned with the corresponding feature quantity obtained by analyzing the uttered speech.

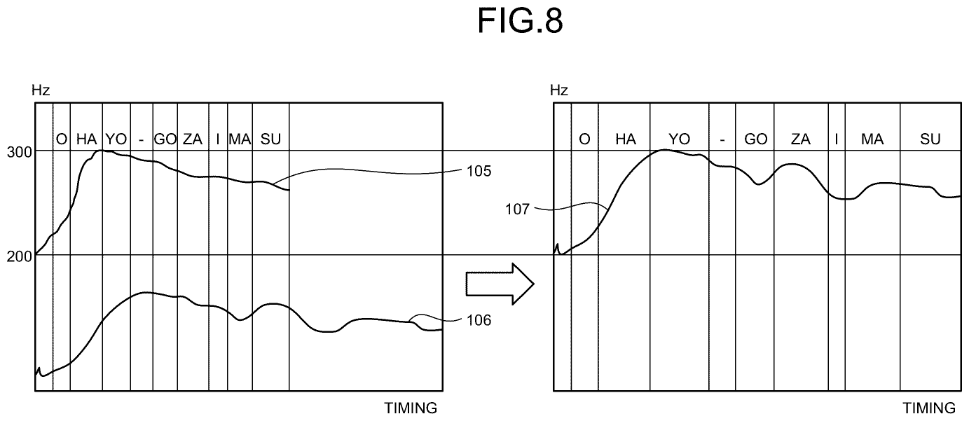

FIG. 8 is a diagram for explaining an example of the operations performed by the editing unit 23 according to the second embodiment. The example illustrated in FIG. 8 is about the operations performed when the editing unit 23 receives a projection instruction with respect to the pitch feature quantity of the uttered speech of the input text. Herein, a pitch feature quantity 105 represents the pitch feature quantity generated by the metrical feature quantity decoder 22. A pitch feature quantity 106 represents the pitch feature quantity of the uttered speech of the input text (for example, the uttered speech of the user). A pitch feature quantity 107 represents the pitch feature quantity generated by the editing unit 23. For example, the editing unit 23 generates the pitch feature quantity 107 by editing such that the maximum value and the minimum value (or the average and the dispersion) of the pitch feature quantity 106 matches the maximum value and the minimum value (or the average and the dispersion) of the pitch feature quantity 105.

As explained above, in the speech synthesis device 10-2 according to the second embodiment, the first processing unit 2-2 outputs the metrical feature quantity 103, and the editing unit 23 reflects the editing instruction by the user. That is, since the metrical feature quantity 103 of the entire input text is output before the generation of the speech waveforms 104, detailed editing of the entire input text can be performed before the generation of the waveforms. In the conventional technology, in the case of successively outputting all acoustic feature quantities and the speech waveforms 104 as the improvement measure for the response time, detailed editing with respect to the metrical feature quantity 103 of the entire input text is difficult.

In the speech synthesis device 10-2 according to the second embodiment, before the second processing unit 3 obtains the speech waveforms 104, it becomes possible to perform detailed editing of the pitch of the entire input text in units of the speech frame. With the feature, the second processing unit 3 can synthesize the speech waveforms 104 in which the detailed editing instruction by the user with respect to the metrical feature quantity 103 is reflected.

### Third Embodiment

Given below is the description of a third embodiment. In the third embodiment, the similar explanation to the explanation given in the first embodiment is not repeated. Thus, the explanation is given only about the differences with the first embodiment.

### Exemplary Functional Configuration

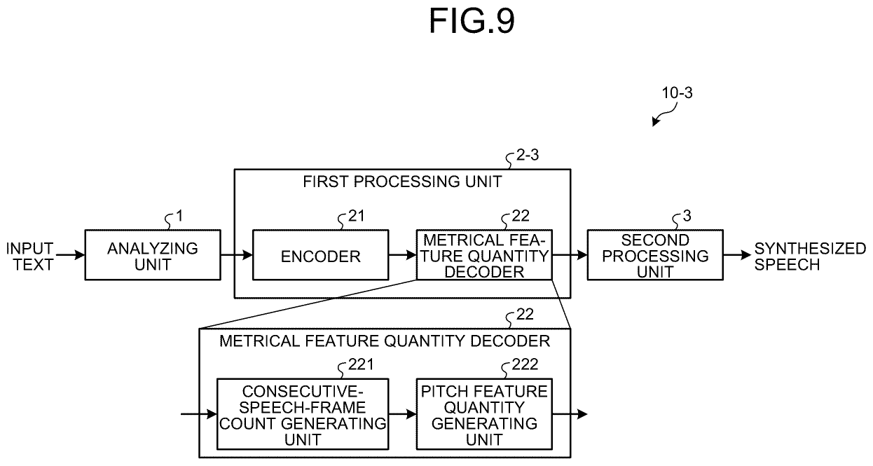

FIG. 9 is a diagram illustrating an exemplary functional configuration of a speech synthesis device 10-3 according to the third embodiment. In the speech synthesis device 10-3 according to the third embodiment, the speech frames are set based on the pitch. More particularly, the interval between the speech frames is changed to be the pitch cycle. With the feature, in the third embodiment, it becomes possible to apply precise speech analysis based on the pitch synchronization analysis.

The speech synthesis device 10-3 according to the third embodiment includes the analyzing unit 1, a first processing unit 2-3, and the second processing unit 3. The first processing unit 2-3 further includes the encoder 21 and the metrical feature quantity decoder 22. The metrical feature quantity decoder 22 further includes the consecutive-speech-frame count generating unit 221 and the pitch feature quantity generating unit 222.

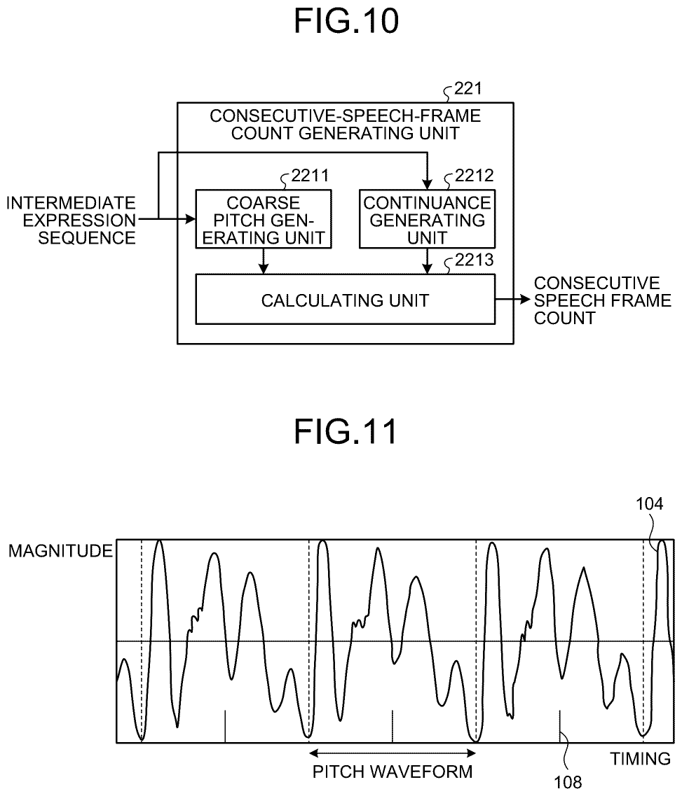

FIG. 10 is a diagram illustrating an exemplary functional configuration of the consecutive-speech-frame count generating unit 221 according to the third embodiment. The consecutive-speech-frame count generating unit 221 according to the third embodiment includes a coarse pitch generating unit 2211, a continuance generating unit 2212, and a calculating unit 2213.

The coarse pitch generating unit 2211 generates the average pitch feature quantity of each vector included in the intermediate expression sequence 102. The continuance generating unit 2212 generates the continuance (i.e., continuance time) of each vector included in the intermediate expression sequence 102. The average pitch feature quantity indicates the average of the pitch feature quantities of the speech frames included in the speech section corresponding to each vector, and the continuance indicates the period of time over which a speech section spans.

The calculating unit 2213 calculates, from the average pitch feature quantity and the continuance of each vector included in the intermediate expression sequence 102, a pitch waveform count indicating the number of pitch waveforms.

A pitch waveform represents the unit for waveform clipping in each speech frame according to the pitch synchronization analysis method.

FIG. 11 is a diagram illustrating an example of pitch waveforms according to the third embodiment. A pitch waveform is obtained as follows. Firstly, from the pitch feature quantity of each speech frame as included in the metrical feature quantity, the waveform generating unit 312 creates pitch mark information 108 that indicates the central timing of each cycle of the cyclic speech waveforms 104.

Then, the waveform generating unit 312 sets the positions of the pitch mark information 108 as the central positions and synthesizes the speech waveforms 104 based on the pitch cycle. By performing the synthesis with the appropriately-provided positions of the pitch mark information 108, it becomes possible to achieve appropriate synthesis that also deals with the local changes in the speech waveforms, resulting in reduction of deterioration in the speech quality.

However, among the sections of the same duration, a section having a higher pitch has a proportionally greater number of pitch waveforms, and a section having a lower pitch has a proportionally smaller number of pitch waveforms. Hence, there are times when the speech frame count in each section is different. For that reason, instead of directly calculating the consecutive speech frame count (the pitch waveform count) of each vector included in the intermediate expression sequence 102, the consecutive speech frame count is calculated from the continuance and the average pitch feature quantity of that vector.

### Example of Speech Synthesis Method

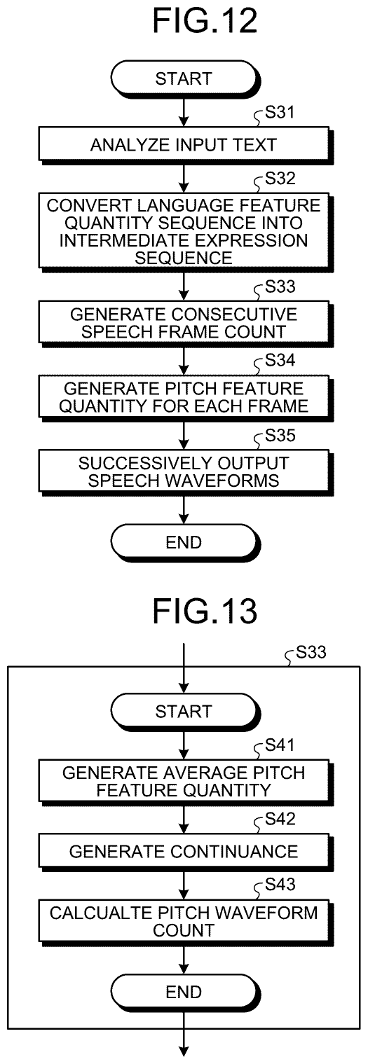

FIG. 12 is a flowchart for explaining an example of a speech synthesis method according to the third embodiment. Firstly, the analyzing unit 1 analyzes the input text and outputs the language feature quantity sequence 101 that includes one or more vectors indicating the language feature quantity (Step S31). Then, the encoder 21 converts the language feature quantity sequence 101 into the intermediate expression sequence 102 (Step S32).

Subsequently, the consecutive-speech-frame count generating unit 221 generates the consecutive speech frame count of each vector included in the intermediate expression sequence 102 (Step S33). Then, the pitch feature quantity generating unit 222 generates the pitch feature quantity in each speech frame (Step S34).

Subsequently, the second processing unit 3 (the speech waveform decoder 31) successively outputs the speech waveforms 104 according to the intermediate expression sequence 102 and the metrical feature quantity 103 (Step S35).

### Details of Consecutive-Speech-Frame Count Generation Operation

FIG. 13 is a diagram for explaining an example of the operations performed by the consecutive-speech-frame count generating unit 221 according to the third embodiment. Firstly, the coarse pitch generating unit 2211 generates the average pitch feature quantity of each vector included in the intermediate expression sequence 102 (Step S41). Then, the continuance generating unit 2212 generates the continuance of each vector included in the intermediate expression sequence 102 (Step S42). Meanwhile, the operations at Steps S41 and S42 can be performed in reverse order too.

Then, from the average pitch feature quantity and the continuance of each vector included in the intermediate expression sequence 102, the calculating unit 2213 calculates the pitch waveform count of each vector (Step S43). The pitch waveform count obtained at Step S43 is output as the consecutive speech frame count.

### Details of Each Constituent Element

The coarse pitch generating unit 2211 and the continuance generating unit 2212 make use of the neural network included in the second neural network and generate, from the intermediate expression sequence 102, the average pitch feature quantity and the continuance, respectively, of each vector included in the intermediate expression sequence 102. Examples of the structure of a neural network include a multi-layer perceptron, a convolution structure, and a recurrent structure. Particularly, if a convolution structure and a recurrent structure are used, the time-series information can be reflected in the average pitch feature quantity and the continuance.

The calculating unit 2213 calculates, from the average pitch feature quantity and the continuance of each vector included in the intermediate expression sequence 102, the pitch waveform count of each vector. For example, if the average pitch feature quantity of a particular vector (intermediate expression) in the intermediate expression sequence 102 has an average basic frequency “f” (Hz) and has a continuance “d” (sec), a pitch waveform count “n” of that vector (intermediate expression) is calculated as n=f×d.

In addition to using the intermediate expression sequence 102, the pitch feature quantity generating unit 222 can make use of the average pitch feature quantity of each vector included in the intermediate expression sequence 102 and obtain the pitch in each speech frame. That results in a decrease in the difference between the average pitch feature quantity generated by the coarse pitch generating unit 2211 and the actually-generated pitch, and it can be expected to achieve the synthesized speech (the speech waveforms 104) that is close to the continuance generated by the continuance generating unit 2212.

As explained above, in the speech synthesis device 10-3 according to the third embodiment, the operations are divided between the first processing unit 2-3 that generates the metrical feature quantity 103 and the second processing unit 3 that generates the spectral feature quantity and the speech waveforms 104. Moreover, the speech frames are set based on the pitch. This enables, by the speech synthesis device 10-3 according to the third embodiment, precise speech analysis based on the pitch synchronization analysis, thereby enabling achieving enhancement in the quality of the synthesized speech (the speech waveforms 104).

### Fourth Embodiment

Given below is the description of a fourth embodiment. In the fourth embodiment, the similar explanation to the explanation given in the first embodiment is not repeated. Thus, the explanation is given only about the differences with the first embodiment.

### Exemplary Functional Configuration

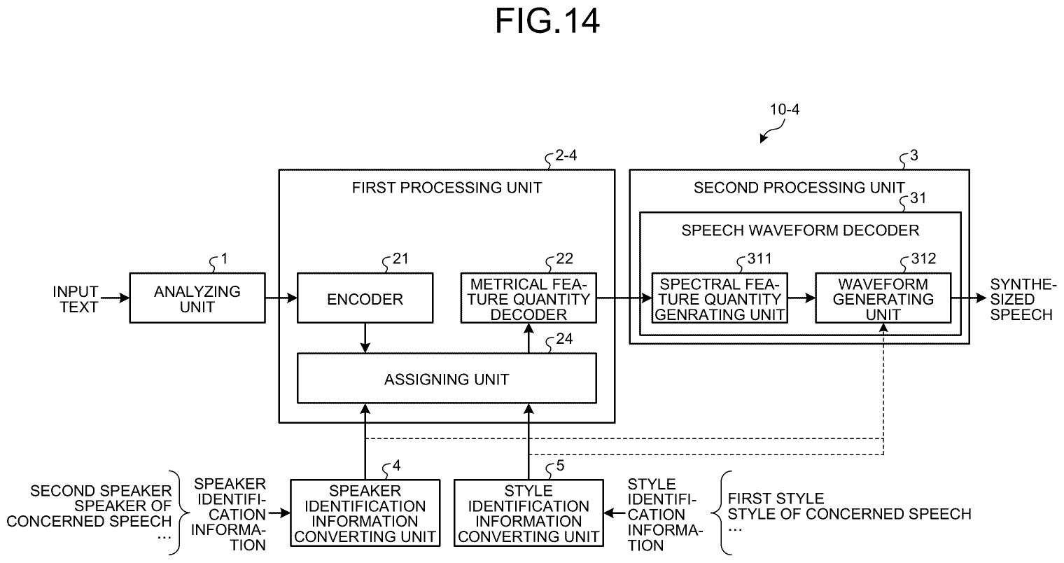

FIG. 14 is a diagram illustrating an exemplary functional configuration of a speech synthesis device 10-4 according to the fourth embodiment. The speech synthesis device 10-4 according to the fourth embodiment includes the analyzing unit 1, a first processing unit 2-4, the second processing unit 3, a speaker identification information converting unit 4, and a style identification information converting unit 5. The first processing unit 2-4 further includes the encoder 21, the metrical feature quantity decoder 22, and an assigning unit 24.

In the speech synthesis device 10-4 according to the fourth embodiment, because of the speaker identification information converting unit 4, the style identification information converting unit 5, and the assigning unit 24, speaker identification information and style identification information gets reflected in the synthesized speech (the speech waveforms 104). This enables, by the speech synthesis device 10-4 according to the fourth embodiment, obtaining the synthesized speech of a plurality of speakers and a plurality of styles.

The speaker identification information enables identification of the input speaker. For example, the speaker identification information is indicated as “the second speaker (a speaker identified by a number)” and “the speaker of the concerned speech (the speaker presented by the uttered speech)”.

The style identification information enables identification of the speaking style (for example, emotions). For example, the style identification information is indicated as “the first style (a style identified by a number)” and “the style of the concerned speech (the style presented by the uttered speech).

The speaker identification information converting unit 4 converts the speaker identification information into a speaker vector representing the feature information of the speaker. A speaker vector is for enabling the use of the speaker vector information in the speech synthesis device 10-4. For example, when the speaker identification information contains the specification of a speaker who is synthesizable in the speech synthesis device 10-4, the speaker vector represents the vector of the embedded expression corresponding to that speaker. Alternatively, when the speaker identification information represents the separately-provided uttered speech of a speaker; for example, as proposed in Z. Wu, et al., “A Study of speaker adaptation for DNN-based speech synthesis”, in Proc. Interspeech 2015, 2015, the speaker vector is obtained from an acoustic feature quantity of the uttered speech, such as the i-vector, and from a statistical model used in speaker identification.

The style identification information converting unit 5 converts the style identification information identifying the speaking style, into a style vector representing the feature information of the style. Similarly to a speaker vector, a style vector is for enabling the use of the style vector information in the speech synthesis device 10-4. For example, when the style identification information contains the specification of a style that is synthesizable in the speech synthesis device 10-4, the style vector represents the vector of the embedded expression corresponding to that style. Alternatively, when the style identification information represents the uttered speech based on a separately-provided style; for example, as proposed in Global Style Tokens (GST) in Y. Wang, et al., “Style Tokens: Unsupervised Style Modeling, Control and Transfer in End-to-End Speech Synthesis”, in Proceeding of the 35th International Conference on Machine Learning, PMLR 80:5180-5189, 2018, the style vector is obtained by conversion of the acoustic feature quantity of the uttered speech according to a neural network.

The assigning unit 24 assigns, to the intermediate expression sequence 102 obtained by the encoder 21, feature information indicated by the speaker vector and the style vector.

### Example of Speech Synthesis Method

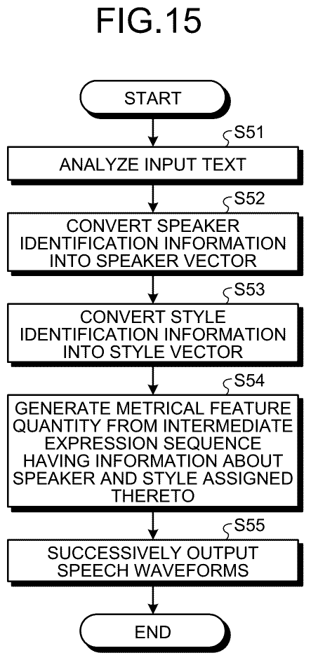

FIG. 15 is a flowchart for explaining an example of a speech synthesis method according to the fourth embodiment. Firstly, the analyzing unit 1 analyzes the input text and outputs the language feature quantity sequence 101 that includes one or more vectors indicating the language feature quantity (Step S51). Then, the speaker identification information converting unit 4 converts the speaker identification information into a speaker vector according to the method explained above (Step S52). Subsequently, the style identification information converting unit 5 converts the style identification information into a style vector according to the method explained above (Step S53). Meanwhile, the operations at Steps S52 and S53 can be performed in reverse order too.

Then, the assigning unit 24 assigns information such as the speaker vector and the style vector to the intermediate expression sequence 102; and the metrical feature quantity decoder 22 generates the metrical feature quantity 103 from the intermediate expression sequence 102 (Step S54). Subsequently, the second processing unit 3 (the speech waveform decoder 31) successively outputs the speech waveforms 104 according to the intermediate expression sequence 102 and the metrical feature quantity 103 (Step S55).

### Details of Operations Performed by First Processing Unit

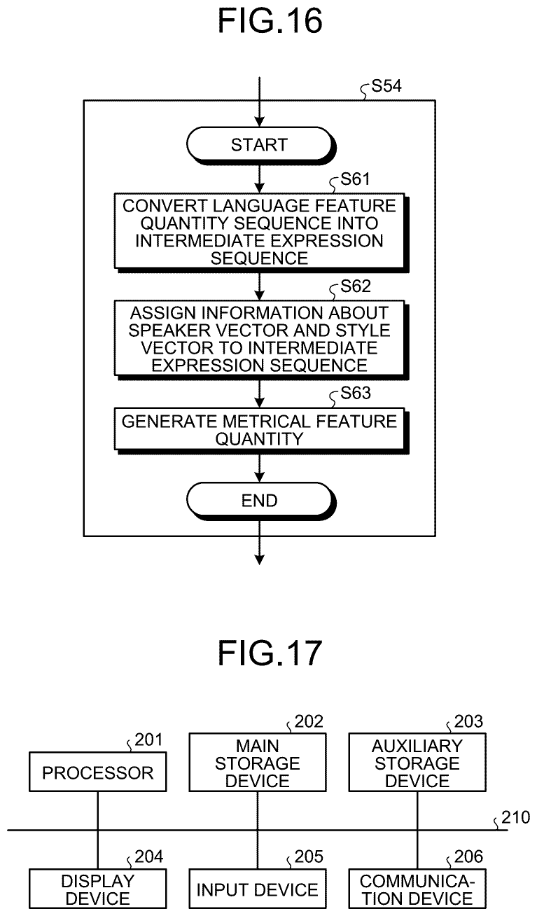

FIG. 16 is a diagram for explaining an example of the operations performed by the first processing unit 2-4 according to the fourth embodiment. Firstly, the encoder 21 converts the language feature quantity sequence 101 into the intermediate expression sequence 102 (Step S61).

Then, the assigning unit 24 assigns information such as the speaker vector and the style vector to the intermediate expression sequence 102 (Step S62).

For the assignment method to be implemented at Step S62, some methods are thinkable. For example, information can be assigned to the intermediate expression sequence 102 by adding the speaker vector and the style vector to each vector (intermediate expression) included in the intermediate expression sequence 102.

Alternatively, information can be assigned to the intermediate expression sequence 102 by coupling the speaker vector and the style vector with each vector (intermediate expression) included in the intermediate expression sequence 102. More particularly, by combining the components of an m₁-dimensional speaker vector and the components of an m-dimensional style vector with the components of an n-dimensional vector (intermediate expression), and forming an n+m₁+m₂-dimensional vector, information can be assigned to the intermediate expression sequence 102.

Moreover, for example, the intermediate expression sequence 102 having the speaker vector and the style vector coupled therewith can be further subjected to linear transformation, so that the intermediate expression sequence 102 having the speaker vector and the style vector coupled therewith can be converted into a more appropriate vector expression.

Subsequently, the metrical feature quantity decoder 22 generates the metrical feature quantity 103 from the intermediate expression sequence 102 obtained at Step S62 (Step S63).

Thus, the speaker/style information is reflected in the intermediate expression sequence 102 obtained at Step S62 and in the metrical feature quantity 103 generated at Step S63. Hence, the speech waveforms 104 that are subsequently generated by the second processing unit 3 have the features of the concerned speaker and the features of the concerned style.

Meanwhile, in the case in which the waveform generating unit 312 of the speech waveform decoder 31 of the second processing unit 3 generates waveforms using the neural network included in the third neural network, that neural network can make use of the speaker vector and the style vector. With such usability, an improvement is expectable for the reproducibility of, for example, the speaker and the style in the synthesized speech (the speech waveforms 104).

As explained above, in the speech synthesis device 10-4 according to the fourth embodiment, by receiving the speaker identification information and the style identification information to be reflected in the speech waveforms 104, a synthesized speech (the speech waveforms 104) of a plurality of speakers and styles is obtainable.

### Modification Example

In the speech synthesis device 10 (10-2, 10-3, and 10-4) according to the first embodiment (to the fourth embodiment), the analyzing unit 1 can divide the input text into a plurality of partial texts and can output the language feature quantity sequence 101 for each partial text. For example, when the input text is made of a plurality of sentences, it can be divided into partial texts on the basis of the sentences, and the language feature quantity sequence 101 can be obtained for each partial text. When a plurality of language feature quantity sequences 101 is output, the subsequent operations are performed with respect to each language feature quantity sequence 101. For example, each language feature quantity sequence 101 can be sequentially processed in a chronological order. Alternatively, for example, a plurality of language feature quantity sequences 101 can be processed in parallel.

The neural network used in the speech synthesis device 10 (10-2, 10-3, and 10-4) according to the first embodiment (to the fourth embodiment) is learnt according to a statistical method. At that time, if some neural networks are simultaneously learnt, overall optimum parameters are obtainable.

For example, in the speech synthesis device 10 according to the first embodiment, the neural network used in the first processing unit 2 and the neural network used in the spectral feature quantity generating unit 311 are optimized in a simultaneous manner. This enables, by the speech synthesis device 10, optimal neural networks to be used for the generation of both the metrical feature quantity 103 and the spectral feature quantity.

Lastly, the explanation is given about an exemplary hardware configuration of the speech synthesis device 10 (10-2, 10-3, and 10-4) according to the first embodiment (to the fourth embodiment). The neural network used in the speech synthesis device 10 (10-2, 10-3, and 10-4) according to the first embodiment (to the fourth embodiment) can be implemented using an arbitrary computer device serving as the basic hardware.

### Exemplary Hardware Configuration

FIG. 17 is a diagram illustrating an exemplary hardware configuration of the speech synthesis device 10 (10-2, 10-3, and 10-4) according to the first embodiment (to the fourth embodiment). The neural network used in the speech synthesis device 10 (10-2, 10-3, and 10-4) according to the first embodiment (to the fourth embodiment) includes a processor 201, a main storage device 202, an auxiliary storage device 203, a display device 204, an input device 205, and a communication device 206. The processor 201, the main storage device 202, the auxiliary storage device 203, the display device 204, the input device 205, and the communication device 206 are connected to each other via a bus 210.

Meanwhile, the speech synthesis device 10 (10-2, 10-3, and 10-4) need not include some part of the abovementioned configuration. For example, when it is possible to utilize the input function and the display function of an external device, the speech synthesis device 10 (10-2, 10-3, and 10-4) need not include the display device 204 and the input device 205.

The processor 201 executes a computer program that has been read from the auxiliary storage device 203 into the main storage device 202. The main storage device 202 represents a memory such as a read only memory (ROM) or a random access memory (RAM). The auxiliary storage device 203 represents a hard disk drive (HDD) or a memory card.

The display device 204 is, for example, a liquid crystal display. The input device 205 represents an interface for operating the speech synthesis device 10 (10-2, 10-3, and 10-4). Meanwhile, the display device 204 and the input device 205 can alternatively be implemented using a touch-sensitive panel equipped with the display function and the input function. The communication device 206 represents an interface for communicating with other devices.

For example, the computer program executed in the speech synthesis device 10 (10-2, 10-3, and 10-4) is recorded as an installable file or an executable file in a computer-readable memory medium such as a memory card, a hard disk, a CD-RW, a CD-ROM, a CD-R, a DVD-RAM, or a DVD-R; and is provided as a computer program product.

Alternatively, for example, the computer program executed in the speech synthesis device 10 (10-2, 10-3, and 10-4) can be stored in a downloadable manner in a computer connected to a network such as the Internet.

Still alternatively, the computer program executed in the speech synthesis device 10 (10-2, 10-3, and 10-4) can be distributed via a network such as the Internet without involving the downloading task. More particularly, the configuration can be such that the speech synthesis operation is performed according to, what is called, an application service provider (ASP) service with which, without transferring the computer program from a server computer, the processing functions are implemented only according to the execution instruction and the result acquisition.

Still alternatively, the computer program executed in the speech synthesis device 10 (10-2, 10-3, and 10-4) can be stored in advance in a ROM.

The computer program executed in the speech synthesis device 10 (10-2, 10-3, and 10-4) has a modular configuration that, from among the functional configuration explained earlier, includes functions implementable also by a computer program. As the actual hardware, the processor 201 reads the computer program from a memory medium and executes it, so that each such function gets loaded in the main storage device 202. That is, each functional block gets generated in the main storage device 202.

Meanwhile, some or all of the abovementioned functions can be implemented not by using software but by using hardware such as an integrated circuit (IC).

Moreover, the functions can be implemented using a plurality of processors 201. In that case, each processor 201 either can implement one of the functions, or can implement two or more functions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A speech synthesis device comprising:
one or more hardware processors configured to function as:
an analyzing unit that analyzes an input text and generates a language feature quantity sequence that includes one or more vectors indicating a language feature quantity;
a first processing unit; and
a second processing unit, wherein
the first processing unit includes
an encoder that converts the language feature quantity sequence into an intermediate expression sequence that includes one or more vectors indicating a latent variable, using a first neural network, and
a metrical feature quantity decoder that generates a metrical feature quantity from the intermediate expression sequence using a second neural network, and
the second processing unit includes a speech waveform decoder that successively generates a speech waveform from the intermediate expression sequence and the metrical feature quantity using a third neural network.

2. The speech synthesis device according to claim 1, wherein the speech waveform decoder of the second processing unit includes
a spectral feature quantity generating unit that generates, in a chronological order and from the intermediate expression sequence and the metrical feature quantity, a spectral feature quantity for a number of speech frames corresponding to a predetermined number of samples, and
a waveform generating unit that generates, in a chronological order, the speech waveform for each set of predetermined number of samples, and successively generates the speech waveform.

3. The speech synthesis device according to claim 2, wherein,
using a neural network that is included in the third neural network and that has at least either a recurrent structure or a convolution structure, the spectral feature quantity generating unit generates, in a chronological order, the spectral feature quantity from the intermediate expression sequence and the metrical feature quantity.

4. The speech synthesis device according to claim 1, wherein the metrical feature quantity decoder includes
a consecutive-speech-frame count generating unit that generates a consecutive speech frame count of each vector included in the intermediate expression sequence, and
a pitch feature quantity generating unit that, based on the consecutive speech frame count, generates a pitch feature quantity in each speech frame using a neural network included in the second neural network.

5. The speech synthesis device according to claim 4, wherein
a speech frame is defined based on a pitch, and
the consecutive-speech-frame count generating unit includes
a coarse pitch generating unit that generates an average pitch feature quantity of each vector included in the intermediate expression sequence,
a continuance generating unit that generates continuance of each vector included in the intermediate expression sequence, and
a calculating unit that calculates a pitch waveform count from the average pitch feature quantity and the continuance.

6. The speech synthesis device according to claim 1, wherein
the first processing unit further includes an editing unit that edits the metrical feature quantity, and
the second processing unit either receives a metrical feature quantity generated by the metrical feature quantity decoder or receives a metrical feature quantity edited by the editing unit.

7. The speech synthesis device according to claim 6, wherein
the editing unit receives an editing instruction by a user with respect to the metrical feature quantity and edits the metrical feature quantity based on the editing instruction by the user, and
the editing instruction by the user includes
a modification instruction for modifying a value of the metrical feature quantity, or
a projection instruction for projection onto a metrical feature quantity obtained by performing a speech analysis of uttered speech in the input text.

8. The speech synthesis device according to claim 1, wherein the one or more hardware processors are configured to further function as a speaker identification information converting unit that converts speaker identification information identifying a speaker, into a speaker vector representing feature information of the speaker, wherein
the first processing unit further includes an assigning unit that assigns feature information of the speaker vector to the intermediate expression sequence.

9. The speech synthesis device according to claim 1, wherein the one or more hardware processors are configured to further function as a style identification information converting unit that converts style information identifying a style of speaking, into a style vector representing feature information of the style, wherein
the first processing unit further includes an assigning unit that assigns feature information of the style vector to the intermediate expression sequence.

10. A speech synthesis method implemented by a computer, the method comprising:
by an analyzing unit, analyzing an input text and generating a language feature quantity sequence that includes one or more vectors indicating a language feature quantity;
by a first processing unit, converting the language feature quantity sequence into an intermediate expression sequence that includes one or more vectors indicating a latent variable, using a first neural network;
by the first processing unit, generating a metrical feature quantity from the intermediate expression sequence using a second neural network; and
by a second processing unit, successively generating a speech waveform from the intermediate expression sequence and the metrical feature quantity using a third neural network.

11. A computer program product having a non-transitory computer readable medium including programmed instructions stored thereon, wherein the instructions, when executed by a computer, cause the computer to function as:
an analyzing unit that analyzes an input text and generates a language feature quantity sequence that includes one or more vectors indicating a language feature quantity;
a first processing unit; and
a second processing unit, wherein
the first processing unit includes
an encoder that converts the language feature quantity sequence into an intermediate expression sequence that includes one or more vectors indicating a latent variable, using a first neural network, and
a metrical feature quantity decoder that generates a metrical feature quantity from the intermediate expression sequence using a second neural network, and
the second processing unit includes a speech waveform decoder that successively generates a speech waveform from the intermediate expression sequence and the metrical feature quantity using a third neural network.
